(19) United States
(12) Patent Application Publication
(10) Pub. No.: US 2005/0231941 A1
(43) Pub. Date: Oct. 20, 2005

(54) Computer peripheral apparatus with illumination

(76) Inventor: Cheng Yu Huang, Taipei (TW)

Correspondence Address: TROXELL LAW OFFICE PLLC;SUITE 1404, 5205 LEESBURG PIKE, FALLS CHURCH, VA, 22041, US

(21) Appl. No.: 10/851,172

(22) Filed: May 24, 2004

(30) Foreign Application Priority Data
Apr. 16, 2004 (TW) 093205907

(51) Int. Cl. F21V 33/00

(52) U.S. Cl. 362/208; 362/200; 362/800

(57) ABSTRACT

The present invention provides an apparatus having a function of illumination of electric light anytime, which is connected via USB, 1394 or PS2 transmission circuit. The structure thereof uses USB or the aforementioned attachment ports to connect and is charged by storage batteries for illumination. When the illumination apparatus is embodied, USB, 1394 or PS2 attachment ports (HUB) or the card reading unit can be set up on the apparatus to become a multifunctional computer peripheral apparatus.

### BACKGROUND OF THE INVENTION

Known as USB (Universal Serial Bus), IEEE (Institute of Electric Electronic Engineer), 1394 (six pins) and PS2 connecting systems, they all have functions of connecting relative computer products. The best function of the aforementioned USB, 1394 and PS2 connecting systems is letting multiple computers or peripheral equipment connect with a computer host collected via the hub or connecting ports to resolve connecting and power supply problems between computers and peripheral equipment.

The best feature of USB, 1394 and PS2 connecting systems is that the electric lines comprise approximately four to six sub-lines wherein a number of sub-lines are signal lines for transmitting data signals and the other ones are power lines for supplying low voltage (e.g. 5V) and low current (e.g. 100 mA˜500 mA), wherein at least one sub-line thereof is ground. Given the above, the USB, 1394 and PS2 connecting devices are transmitting stations for transmitting data alone or simultaneously transmitting data signals and supplying power.

The connecting slots or plugs (HUB) of USB, 1394 and PS2 systems are commonly set up on computer hosts, portable computers or HUBs so that connections or conversions are more popular and convenient.

When night comes, it is natural that darkness covers half the earth. The technology is developed to supply power and illumination, however, if the power supply is terminated at night, because of fire or malfunction of the electrical equipment, it will become suddenly dark. While becoming dark in general environments, even though there may be flashlights or charge batteries for backup at home, people will be still panic and not find the desired illumination articles.

Each aforementioned computer transmitting line has power lines and signal lines and has features of transmitting power and signals at the same time which can be invented to be different practical products. Therefore, the inventor uses the aforementioned transmitting lines with charges on the computers to invent “computer peripheral apparatus with illumination.”

The present invention applies and designs the features of transmitting power and signals of USB, 1394 or PS2 to provide an illumination function of being an electric torch anytime, which is connected via USB, 1394 or PS2 and connecting lines and charged by batteries. Accordingly, users can connect to the apparatus by the connecting lines and charge the apparatus. Once power failure occurs, it will automatically illuminate.

Besides, in recent years, popularization of computers has brought human beings convenience. To the contrary, since computer technology is developed continuously, the relative functions have gradually increased. Accordingly, computer related peripheral equipment has kept expanding. Furthermore, as local network areas rise, between many computer peripheral equipment and hosts of portable computers, personal computers (PCs), and servers generate many parallel and serial connecting problems; for example, printers, scanners, video monitors, outer disk drivers, keyboards, mice, modems, card readers, digital cameras, outer boxes, etc. The computer peripheral equipment all can connect to each other through the HUB of the aforementioned USB, 1394 or PS2 systems.

Since attachment ports and card readers are the most common devices used by computers, the inventor further designs USB, 1394 or PS2 attachment ports (HUBs) or card readers that are set up on the illumination devices as HUBs or card readers to become a multifunctional practical computer peripheral apparatus, not just night lights for illumination.

### SUMMARY OF THE INVENTION

The present invention applies the features of transmitting power and signals of USB, 1394 or PS2 and designs a structure connected via USB, 1394 or PS2 attachment ports and charged by batteries for being an electric light for illumination anytime. Besides, the illumination device can set up USB, 1394, PS2 attachment ports (HUBs) or card reading units to be attachment (wire collecting) ports and card readers in addition to being electric lights for illumination to become a multifunctional computer peripheral apparatus.

### BRIEF DESCRIPTION OF THE DRAWINGS

FIG. 1 is a stereoscopic diagram of a computer peripheral apparatus with illumination in accordance with the present invention.

FIG. 2 is a stereoscopic diagram from another visual angle of the computer peripheral apparatus with illumination in accordance with the present invention.

FIG. 3 is an explosive stereoscopic diagram of the computer peripheral apparatus with illumination in accordance with the present invention.

FIG. 4 is a stereoscopic diagram of the computer peripheral apparatus with illumination attached with USB connecting slots in accordance with the present invention.

FIG. 5 is a stereoscopic diagram from another visual angle of the computer peripheral apparatus with illumination attached with USB connecting slots in accordance with the present invention.

FIG. 6 is an explosive stereoscopic diagram of the computer peripheral apparatus with illumination, equipped with USB connecting slots, in accordance with the present invention.

FIG. 7 is a stereoscopic diagram of the computer peripheral apparatus with illumination attached with card reading units in accordance with the present invention.

FIG. 8 is a stereoscopic diagram from another visual angle of the computer peripheral apparatus with illumination attached with card reading units in accordance with the present invention.

FIG. 9 is an explosive stereoscopic diagram of the computer peripheral apparatus with illumination, which is equipped with card reading units, in accordance with the present invention.

### DETAILED STRUCTURE AND DESCRIPTION OF THE EMBODIMENTS

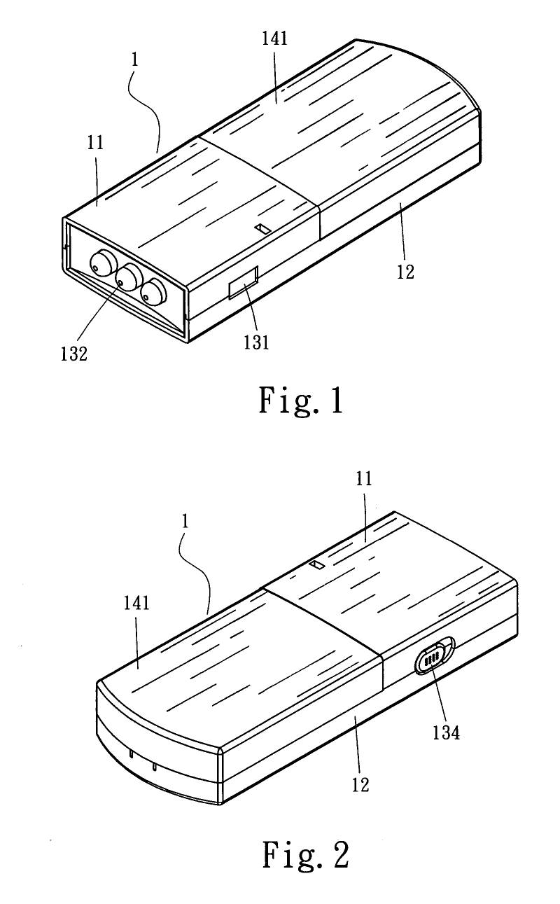

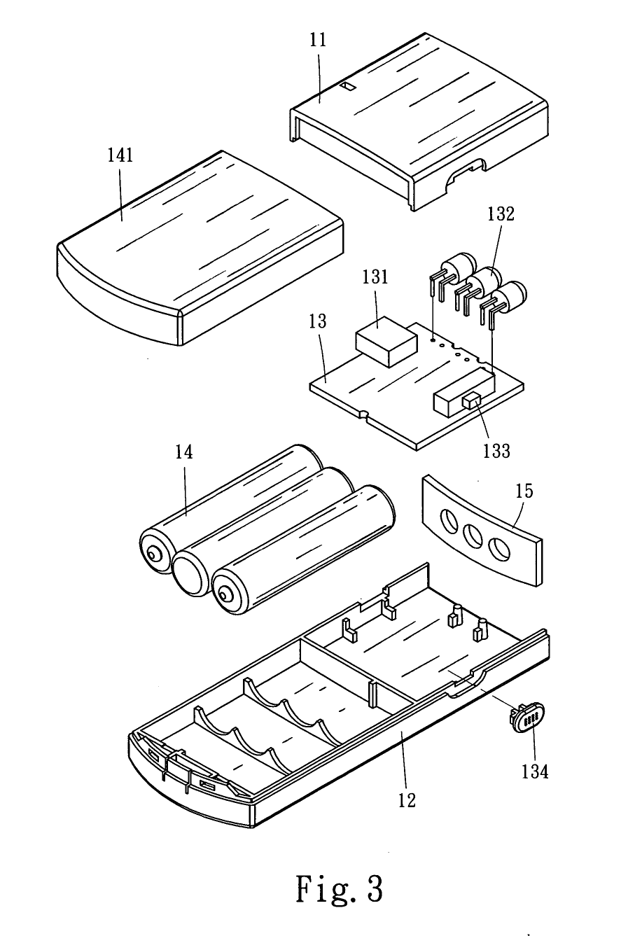

Turn to FIGS. 1 to 3, the computer peripheral apparatus (1) with illumination of the present invention mainly comprises elements of a top housing (11), a bottom housing (12), a circuit board (13), a charging battery (14), a battery cover (141), etc. On the circuit board (13) are a set of USB input terminals (131), a LED illuminator (132), a light switch (133), etc. At a front edge of the LED illuminator (132) is set a lampshade (15). The light switch (133) is coordinated with a switch button (134).

The aforementioned USB input terminal (131) is used as an input for a USB input power signal line which can charge the charging battery (14) as an electric light for illumination anytime.

When embodying the USB input terminal (131) in practice, 1394 or PS2 input terminals can be adapted to be used in relative transmitting systems.

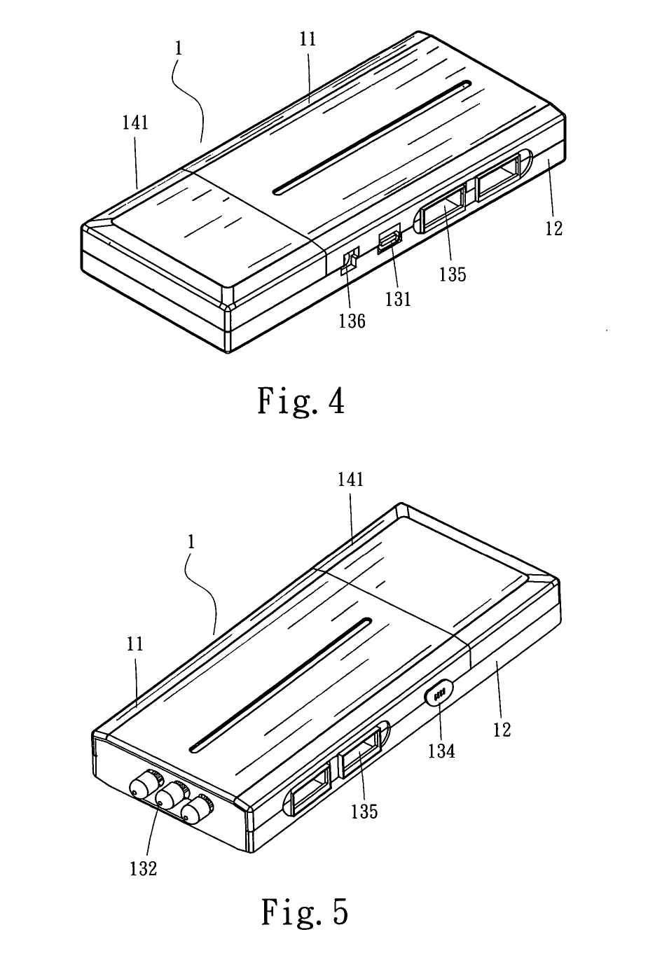

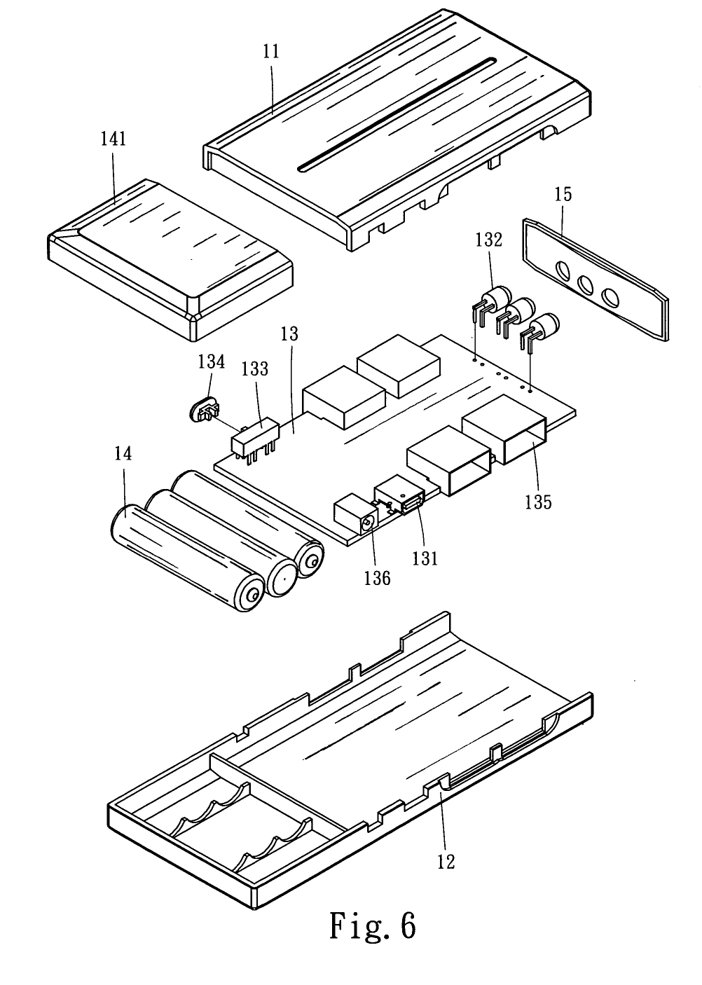

Turn to FIGS. 4 to 6, when embodying the computer peripheral apparatus (1) with illumination of the present invention, on the circuit board (13) can be set a number of USB connecting slots (135) to further comprise computer attachment ports (HUB) for transmitting computer equipment in addition to illumination. Alternatively, a direct current input terminal (136) can be set thereon to supplement the power supply (when it is 2.1 based HUB, an external power supply is needed). Furthermore, the USB connecting slots (133) can be substituted by 1394 or PS2 attachment ports.

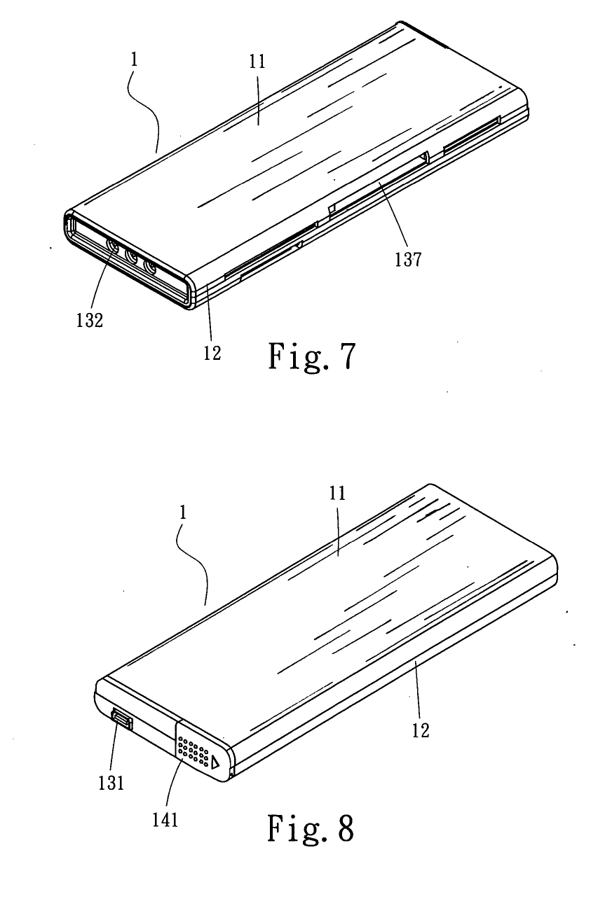

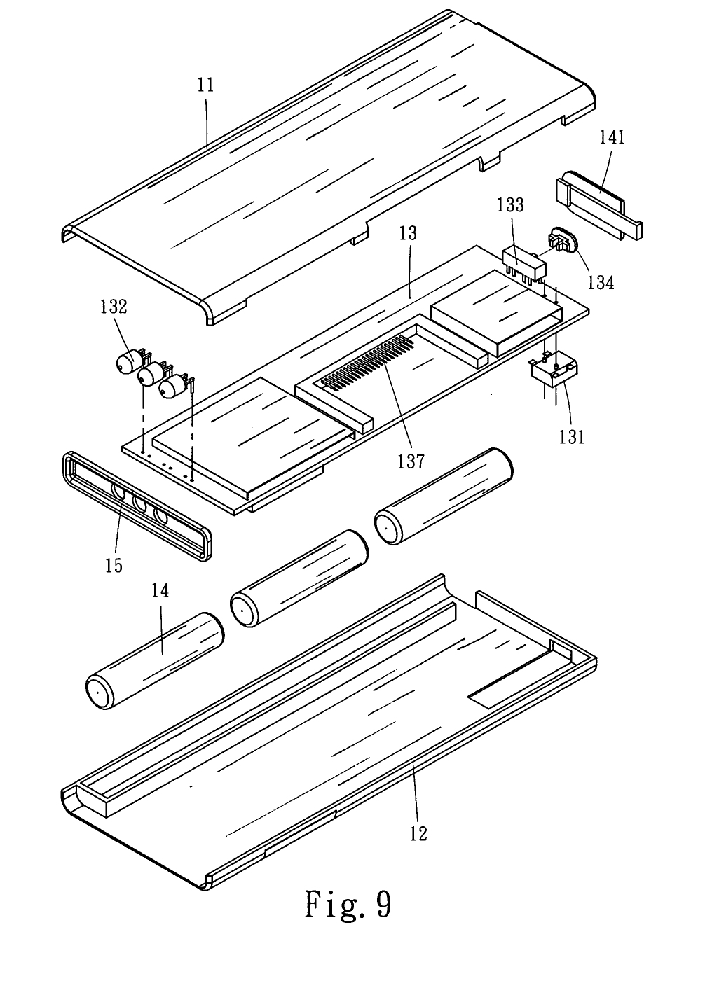

Turn to FIGS. 7 to 9, when embodying the computer peripheral apparatus (1) with illumination of the present invention, on the circuit board (13) can be set a card reading unit (137) to further comprise a computer attachment port with a card reading function in addition to illumination. Furthermore, the USB connecting slots (17) can be substituted by 1394 or PS2 attachment ports.

Given the above, the illumination device of the present invention can further have USB, 1394, PS2 attachment ports or card reading units. In addition to being an electric light for illumination, it can also be used as an attachment port (HUB) and a card reader to become a multifunctional computer peripheral apparatus.

1. A computer peripheral apparatus with illumination mainly comprising elements of a top housing, a bottom housing, a circuit board, a storage battery, a battery cover, a lamp shade, etc., the circuit board further having a USB input terminal, an LED illuminant, a light switch, a switch button, etc., and characterized by connecting the USB input terminal to supply power and charging into the storage battery to be an electric light to illuminate anytime.

2. The computer peripheral apparatus with illumination of claim 1 wherein the USB input terminal can be substituted by a 1394 or PS2 input terminal to adapt for use in relative transmitting systems.

3. The computer peripheral apparatus with illumination of claim 1 wherein a number of USB connecting slots can be set on the circuit board to further comprise computer attachment ports (HUB) for computer equipment connecting and transmitting, not only for illumination.

4. The computer peripheral apparatus with illumination of claim 3 wherein the USB connecting slots also can be 1392 or PS2 connecting slots to be suitably used in relative transmitting systems.

5. The computer peripheral apparatus with illumination of claim 3 wherein the device having the USB connecting slots can set up direct current input terminal thereon to supply direct current.

6. The computer peripheral apparatus with illumination of claim 1 wherein on the circuit board is set a card reading unit to further become a computer card reader for reading cards by the computer, not only with the function of illumination.
